(19) United States
(12) Patent Application Publication
(10) Pub. No.: US 2013/0132005 A1
(43) Pub. Date: May 23, 2013

(54) Process for detecting multiple echoes and bottom echoes

(71) Applicant: Roland WELLE, Oberwolfach (DE)

(72) Inventor: Roland WELLE, Oberwolfach (DE)

(21) Appl. No.: 13/468,574

(22) Filed: May 10, 2012

Related U.S. Application Data
(60) Provisional application No. 61/490,725, filed on May 27, 2011.

(30) Foreign Application Priority Data
May 27, 2011 (EP) 11 167 916.3

(51) Int. Cl. G01F 23/00; G06F 17/00

(52) U.S. Cl. CPC G01F 23/00; G06F 17/00
USPC 702/55

(57) ABSTRACT

A robust process and a device are for detecting multiple echoes and bottom echoes, in which statistical properties of a shared characteristic of two echoes identified in an echo curve are evaluated. This shared characteristic corresponds to a ratio of the positions or the speed values of the two identified echoes. In this way, it may be possible to classify the echoes.

### REFERENCE TO RELATED APPLICATIONS

This application claims the benefit of the filing date of EP Patent Application Serial No. EP 11 167 916.3 filed 27 May 2011 and U.S. Provisional Patent Application Ser. No. 61/490,725 filed 27 May 2011, the disclosures of both applications are hereby incorporated by reference.

### FIELD OF THE INVENTION

The present invention relates to determining the position of a filling material surface when measuring fill levels of all types. In particular, the present invention relates to a fill level measurement device for determining the position of a fill level or of a separating layer in a container, a process for determining the position of a fill level or of a separating layer in a container, a program element and a computer-readable medium.

### TECHNICAL BACKGROUND

In fill level sensors which work by the FMCW or pulse-delay process, electromagnetic or acoustic waves are emitted towards a filling material surface. Subsequently, a sensor shows the echo signals which are reflected by the filling material, the container fixtures and the container itself, and derives from these the position of a surface of at least one of the filling materials which are located in the container.

When acoustic or optical waves are used, the signal produced by the fill level measurement device generally propagates freely towards the filling material surface which is to be measured. In devices which use radar waves to measure the filling material surface, free propagation towards the medium which is to be measured is possible, as is propagation in the interior of a wave guide, which guides the radar waves from the fill level measurement device to the medium. In devices which work on the basis of guided microwaves, the high-frequency signals are guided to the medium along a wave guide.

At the surface of the medium or filling material which is to be measured, part of the impinging signal is reflected, and returns to the fill level measurement device again after a corresponding delay. The non-reflected signal components penetrate into the medium, and propagate further towards the container base in said medium in accordance with the physical properties of said medium. These signals are also reflected at the container base, and after passing through the medium and the superposed atmosphere, they return to the fill level measurement device again.

The fill level measurement device receives the signals reflected at various points, and determines the distance of the filling material from these by known processes.

The determined distance of the filling material is provided externally. It may be provided in an analogue form (4.20 mA interface) or alternatively in a digital form (field bus).

The basic construction of radar fill level sensors is discussed in detail in Peter Devine's book Füllstandmessung mit Radar-Leitfaden für die Prozessindustrie (ISBN 3-00-008216-6).

A common feature of all the processes may be that, on the path from the fill level measurement device to the filling material surface, the signal which is used for the measurement is located in the area of influence of a further medium, which will be referred to hereinafter as the superposed medium. This superposed medium is located between the fill level measurement device and the surface of the medium which is to be measured, and is generally constituted by a liquid or a gaseous atmosphere.

In the vast majority of applications, air is located above the medium which is to be measured. Since the propagation of electromagnetic waves in air only differs from the propagation in a vacuum by a negligible amount, no particular corrections are required to the signals which are reflected back through the air to the fill level measurement device from the filling material, the container fixtures and the container itself.

However, in process containers for the chemical industry, all types of chemical gases and gas mixtures may also be found as a superposed medium. Depending on the physical properties of these gases or gas mixtures, the propagation properties of electromagnetic waves are altered by comparison with propagation in a vacuum or in air.

### SUMMARY OF THE INVENTION

It would be desirable to have a process for robust detection of multiple echoes and bottom echoes.

Aspects of the invention are defined by the features of the independent claims. Developments of the invention are to be found in the dependent claims and in the following description of aspects and embodiments.

In accordance with a first aspect of the invention, a fill measurement device is provided for determining the position of a fill level and/or a separating layer in a container, the fill level measurement device comprising an echo curve detection unit (in the following also referred to as “echo curve detection means”) for detecting an echo curve, an echo identification unit (in the following also referred to as “echo identification means”) for identifying at least two echoes in the echo curve, and a position or speed detection unit (in the following also referred to as “position or speed detection means”) for detecting position or speed values of at least two echoes. The fill level measurement device is configured so as to carry out an echo classification of the at least two echoes, taking into account a sign of a ratio of the detected speed values, the echo classification assigning at least two of the identified echoes of the echo curve to a feature class selected from a group comprising the feature classes bottom echo, multiple echo, anti-correlation echo and fill level echo.

For example, some or even all echoes in the echo curve may be classified by performing the following steps: 1) postulating one of the echoes as fill level echo; 2) classifying another or all other echoes in the echo curve by determining the sign of the ratio of the speed value of this echo and the speed value of the postulated fill level echo and, for example, by also taking into account the value of the ratio.

In other words, the echo classification means decides, on the basis of the sign of a ratio of the speed of two echoes, whether at least one of the echoes is a bottom echo or a multiple echo or an anti-correlation echo.

In accordance with a further aspect of the invention, the fill level measurement device comprises a statistics unit, also referred to as statistical means. The purpose of the statistical means is to evaluate statistical properties of a shared characteristic of at least two echoes, the shared characteristic being a ratio of the positions detected by the position or speed detection means or the detected speed values of two echoes.

The echo identification unit, the position and/or speed detection unit and/or the statistics unit may also be a shared unit, which is configured accordingly so as to carry out the steps and functions described above and in the following.

In accordance with a further aspect of the invention, the fill level measurement device may also be able to identify more than two echoes in the echo curve and detect the respective positions and/or speed values of these echoes and evaluate the corresponding statistical properties of the shared characteristics.

In accordance with a further aspect, the fill level measurement device is configured so as to carry out an echo classification of at least two or all of the identified echoes in the echo curve as a result of the evaluation of the statistical properties of the shared characteristics of identified echoes, the echo classification assigning at least two or else each of the identified echoes of the echo curve to a feature class selected from the group comprising the feature classes bottom echo, multiple echo, anti-correlation echo and filling material echo.

The fill level measurement device may further comprise a tracking unit (tracking means), which places identified echoes in a logical relationship with previously identified echoes. The tracking means may further be set up so as to estimate a probable position of an echo if this echo is absent from the echo curve. This estimation may for example be carried out by introducing an invisible path into a track if an echo is absent.

In other words, the fill level measurement device comprises a tracking unit which groups echoes which are produced by reflections at identical points in the container and which describe identical propagation paths of the signal produced by the fill level measurement device. The tracking means is further configured so as to detect and process the absence of an echo or a reflection of a previously observed reflection point in the echo curve.

In accordance with a further aspect, the fill level measurement device may be able to determine and transmit the classification, position and order of an echo, or even of all of the identified echoes.

In accordance with a further aspect of the invention, the statistics unit may detect the characteristics of at least one or all of the pairs of identified echoes.

In accordance with a further aspect of the invention, the statistics unit represents the echo classification as a histogram, in which each possible feature class of each of the identified echoes is assigned to a probability, which expresses how great the statistical probability is that the corresponding echo actually belongs to the corresponding feature class.

In accordance with a further aspect of the invention, the speed detection unit carries out an analysis on the basis of the position and time differences of previously grouped echoes of an echo track.

In accordance with a further aspect of the invention, the fill level measurement device is configured so as to confirm or revise the echo classification by detecting and evaluating a further echo curve. In other words, continuous speed analysis takes place, by means of which old evaluations and classifications are re-evaluated in that the new speed values and characteristics are taken into account in the statistical evaluation.

In this way, the probabilities that the corresponding echo classification is the correct one may be recalculated after each fill level measurement.

In accordance with a further aspect of the invention, the fill level measurement device is configured for simultaneous identification of multiple echoes and bottom echoes. This may be understood to mean that the bottom echoes and multiple echoes are identified in a single process step.

In accordance with a further aspect of the invention, a process is provided for determining the position of a fill level echo and/or of a separating layer of a filling material in a container, in which at least one echo curve is detected, and subsequently two echoes are identified in the echo curve. Subsequently, positions and/or speed values of the at least two echoes are detected.

Subsequently, an echo classification of the at least two echoes is carried out, taking into account a sign of a ratio of the detected speed values, the echo classification of each of the identified echoes of the echo curve being assigned to a feature class selected from a group comprising the feature classes bottom echo, multiple echo, anti-correlation echo and filling material echo.

Statistical properties of a shared characteristic of the two or more echoes may also be evaluated (that is to say, for example, the shared characteristics of all of the echo pairs of the plurality of identified echoes in the echo curve may be evaluated), the shared characteristic (the shared characteristics) being a ratio (ratios) of the detected positions or the detected speed values of the two echoes (of the corresponding echo pairs).

In accordance with a further aspect of the invention, after a1) the identification of a plurality of echoes in the echo curve is carried out, and after b1) an echo classification of at least two or all of the identified echoes in the echo curve is carried out as a result of the evaluation of the statistical properties of the shared characteristics of at least two or all of the identified echoes, the echo classification assigning at least two or each of the identified echoes of the echo curve to a feature class. This feature class is selected from the group comprising the feature classes bottom echo, multiple echo, anti-correlation echo and filling material echo.

At this point, it should be noted that the process steps mentioned here and in the following may be implemented in the program element and the computer-readable medium, and may in particular be carried out by the fill level measurement device. Moreover, the features mentioned above and in the following of the fill level measurement device may also be implemented as process steps.

In accordance with a further aspect of the invention, after the identification of the plurality of echoes in the echo curve, one of the identified echoes is postulated in an alternating manner to be the fill level echo, the echo classification comprising classifying at least one or all of the remaining identified echoes and calculating the corresponding probabilities of a correct classification.

Thus, in other words, one of the identified echoes is classified in advance as the fill level echo, whereupon the remaining echoes are classified. Subsequently, another echo may be identified as the fill level echo, and the classification may be carried out for the other echoes, and so on.

In accordance with a further aspect of the invention, the echo classifications are confirmed or revised by detecting a further echo curve and carrying out at least the steps (a1) and (b) and adapting the corresponding probabilities of a correct classification.

In accordance with a further aspect of the invention, the echo is classified as a zeroth-order multiple echo at a speed ratio of 0.5 to 1.5, as a first-order multiple echo at a speed ratio of 1.5 to 2.5, as a second-order multiple echo at a speed ratio of 2.5 to 3.5, as a bottom echo at a speed ratio of minus 9 to minus 4, and as an anti-correlation echo at all remaining speed ratios.

In accordance with a further aspect of the invention, a computer-readable medium is provided for storing a program element which, when it is executed on a processor of a fill level measurement device, causes the processor to carry out the steps disclosed above and in the following.

In accordance with a further aspect of the invention, a program element is provided which, when it is executed on a processor of a fill level measurement device, causes the processor to carry out the steps disclosed above and in the following.

### BRIEF DESCRIPTION OF THE DRAWINGS

FIG. 1 shows a fill level measurement device which works by a delay-based process.

FIG. 2 shows process steps for determining the fill level by a delay-based process.

FIG. 3 shows ratios for uneven container covers.

FIG. 4 shows a fill level measurement comprising multiple echoes.

FIG. 5 shows a fill level measurement in a dome shaft.

FIG. 6 shows a fill level measurement without a container cover.

FIG. 7 shows a fill level measurement device according to an embodiment of the invention.

FIG. 8 shows measurement cycles with a fill level measurement device according to an embodiment of the invention.

FIG. 9 is a flow chart for fill level measurement with a fill level measurement device according to an embodiment of the invention.

FIG. 10 is a flow chart for updating a statistic according to an embodiment of the invention.

FIG. 11 shows a definition of echo classes for multiple echo and bottom echo detection.

FIG. 12 shows combinatorics of a statistical unit according to an embodiment of the invention.

FIG. 13 shows states of a statistical unit when a sequence of echoes is tracked correctly.

FIG. 14 shows states of a statistical unit when a sequence of echoes is tracked incorrectly.

### DETAILED DESCRIPTION

The following embodiments concentrate on discussing the frequently encountered application example of a single medium or filling material which is to be measured in a container. However, the described relationships may also be transferred to the application example of two or more different media or filling materials in a container. In connection with a separating layer measurement, the position of a filling material surface may also in particular be the position of a separating layer between two different media or filling materials, which is identical to the position of the filling material surface of the lower of the two filling materials or media in a container for separating layer measurement.

In devices for fill level measurement, various processes can be applied by which the position of a filling material surface in a container can be detected.

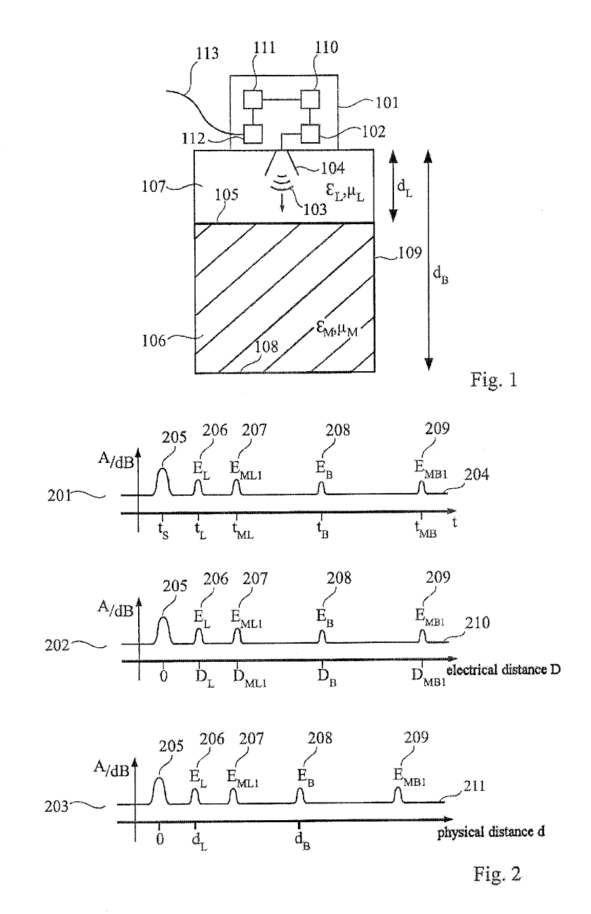

FIG. 1 shows a conventional arrangement for fill level measurement. The container 109 is filled to a fill height d_{B}-d_{L} with a liquid 106. Suppose for example that the space 107 above the liquid is filled with air. In the present example, the liquid is covered with air as a superposed medium.

Using a high-frequency means 102, the fill level measurement device 101 generates an electromagnetic pulse 103 and couples it into a suitable antenna 104, whereupon this pulse propagates at approximately the speed of light towards the filling material surface 105 which is to be measured. The exact speed within the superposed medium is given by:

$${c}_{L} = \frac{{c}_{0}}{\sqrt{{ɛ}_{L} \cdot {μ}_{L}}}$$

wherein c₀ is the speed of light in a vacuum, ε_{L} is the permittivity of the superposed medium, and μ_{L} is the permeability of the superposed medium.

The filling material surface 105 reflects part of the impinging signal energy, whereupon the reflected signal component is propagated back to the fill level measurement device 101 again. The non-reflected signal component penetrates into the liquid 106, and is propagated therein towards the container base at greatly reduced speed. The speed c_{M} of the electromagnetic wave 103 within the liquid 106 is determined by the material properties of the liquid 106:

$${c}_{M} = \frac{{c}_{0}}{\sqrt{{ɛ}_{M} \cdot {μ}_{M}}}$$

wherein c₀ is the speed of light in a vacuum, ε_{M} is the permittivity of the liquid, and μ_{M} is the permeability of the liquid. The residual signal component is also reflected from the base 108 of the container 109, and after a corresponding delay returns to the fill level measurement device 101 again. In the fill level measurement device, the impinging signals are propagated using the high-frequency means 102, and preferably transformed into a low-frequency intermediate frequency range. Using an analogue-digital converter unit 110, the analogue echo curves which are provided by the high-frequency means 102 are digitalised and provided to an evaluation means 111.

The aforementioned components, which are used to provide a digitalised echo curve, that is to say in particular the high-frequency means 102 and the analogue-digital converter unit 110, may for example define an echo curve detection means.

The evaluation means 111 analyses the digitalised echo curve, and determines by known processes, on the basis of the echoes comprised therein, the echo which was produced by the reflection from the filling material surface 105. In addition, the evaluation means determines the exact electrical distance of this echo. Further, the determined electrical distance of the echo is corrected in such a way that effects of the superposed medium 107 on the propagation of the electromagnetic waves are compensated. The compensated distance of the filling material 113 calculated in this manner is passed to an output means 112, which processes the determined value further in accordance with the user's specifications, for example by linearisation, offset correction, or conversion into a fill level d_{E}-d_{L}. The processed measurement value is provided externally to an external communications interface 113. In this context, all established interfaces may be used, in particular 4.20 mA current interfaces, industrial field buses such as HART, Profibus and FF, or even computer interfaces such as RS232, RS485, USB, Ethernet and FireWire.

FIG. 2 again illustrates in detail important steps which are applied in the context of the echo signal processing in the evaluation means 111 for compensating the effects of various media.

The curve sequence 201 initially shows the echo curve 204 detected by the analogue-digital converter unit 110 over time. The echo curve initially comprises the component of the transmission pulse 205 reflected inside the antenna. A short time later, at time t_{L}, a first echo 206 is detected which is caused by the reflection of signal components at the boundary 105 or surface 105 of the medium 106 in the container. A further echo 207 is produced as the first multiple echo of the filling material echo 206, and is detected at time t_{ML}. After passing through the filling material 106, the signal components which penetrate into the medium 106 are reflected from the container base 108, and generate a further echo 208 within the echo curve 204. This bottom echo 208 is detected at time t_{B}. Further, a multiple echo 209 of the bottom echo may be detected at time t_{MB}.

In a first processing step, the time-dependent curve 201 is transformed into a distance-dependent curve 202. During this transformation, it is assumed that the detected curve has been formed exclusively by propagation in a vacuum. The y-axis of the representation 201 is converted into a distance axis by multiplying by the speed of light in a vacuum. In addition, by compensating an offset, it is provided that the echo 205 caused by the antenna 104 receives the distance value 0 m. Further, the distance values are multiplied by a factor of 0.5, so as to compensate the two-way path to the filling material surface and back.

The second representation 202 shows the echo curve as a function of the electrical distance D. The electrical distance corresponds to half of the distance covered by an electromagnetic wave in a vacuum in a particular time. The electrical distance does not take into account any effects of a medium which might possibly lead to slower propagation of the electromagnetic waves. The curve sequence 202 therefore represents an uncompensated but position-based echo curve.

In the present description, electrical distances are always denoted by upper-case letters D, whereas physical distances which can be measured directly from the container are denoted by lower-case letters d.

It may further be possible to compensate the echo curve 210 completely. The third representation 203 shows a fully compensated echo curve 211. So as to achieve a representation of the echo over the physical distance, in the present case the effect of the superposed medium 107 in the range between the positions 0 and D_{L} on the curve sequence 202 has to be taken into account. Between 0 and D_{L}, the electrical distance specifications of the x-axis have to be converted into physical distance specifications in accordance with the following relationship:

$${d}_{i} = \frac{{D}_{i}}{\sqrt{{ɛ}_{L} \cdot {μ}_{L}}}$$

Since 1 is a good approximation to ε_{L} and μ_{L} for air, no correction has to be carried out for this portion in the present example. However, the electrical distance specifications of the x-axis which are greater than or equal to D_{L} have to be converted into physical distance specifications in accordance with the following relationship:

$${d}_{i} = {d}_{L} + \frac{〚 {( D 〛}_{i} - {D}_{L} )}{\sqrt{{ɛ}_{M} \cdot {μ}_{M}}}$$

Finally, the third representation 203 shows the corrected curve. Both the distance of the echo 206 from the filling material surface 105 and the distance of the echo 208 produced by the container base 108 agree with the distances which can be measured from the container 109. The distance of the multiple echo 207 from the filling material surface cannot be measured directly from the container, since the above compensation is only valid for direct reflections. The same applies to the multiple echo 209 of the reflection from the container base 108.

At this point, it should be noted that the conversion into curve sequence 202, that is to say determining the electrical distances of various echoes, is preferably carried out for all of the echoes in the context of the signal processing in the device. The conversion of the echo curve into a compensated echo curve is generally not carried out, and it is sufficient to correct an individual distance value of the filling material surface.

For the application example in FIG. 1, because of previously known values for the permittivity and the permeability of the air, no problems occur in practical application in relation to the distance between the sensor and the filling material surface. Within the technical teaching disclosed herein, it is assumed as a basic principle that the properties of the media located in the container, in particular the permeabilities and the permittivities, are known within the device, for example as a result of being inputted by the user.

DE 102006019191 A1 and WO 2010/071564 A1 relate to processes for automated detection of these characteristics. U.S. Pat. No. 5,438,867 and DE 42 33 324 A1 relate to processes for automated detection of the height d_{B} of the container 109. The processes disclosed therein may be combined with the technical teaching disclosed herein.

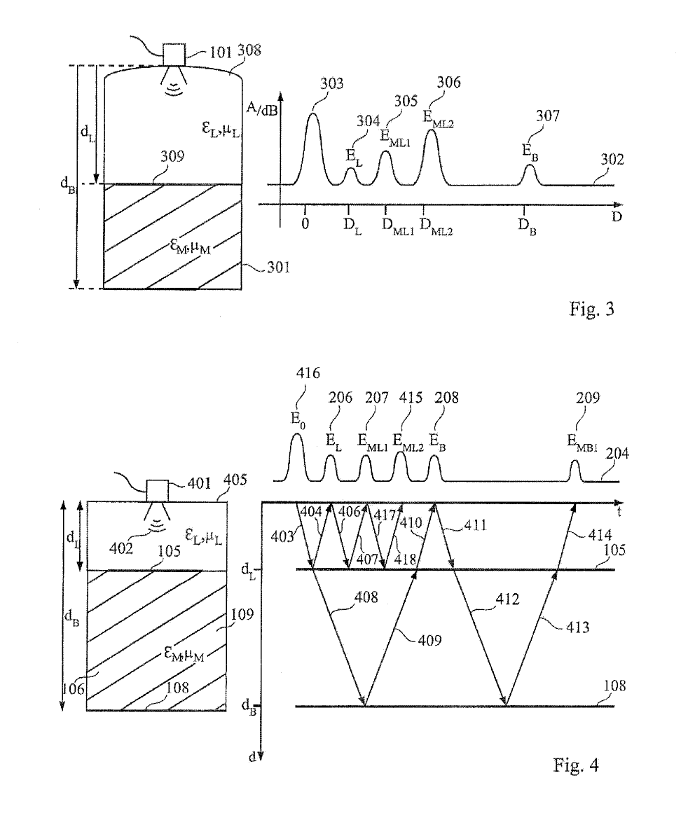

FIG. 1 and the resulting echo curves of FIG. 2 show the ratios in a simple measurement arrangement. Slightly altered reflection ratios occur for example in containers having conical container covers. FIG. 3 shows an example of a container 301 of this type.

Upon comparing the echo curve 302 of the container 301 having a conical container cover 308 with the echo curve 210 of the container 109 having an even container cover, it becomes apparent that the resulting multiple echoes E_{ML1} and E_{ML2} 305, 306 of the reflection from the filling material surface 309 have a much greater amplitude than the echo E_{L} 304 of the direct filling material reflection. The observed state of affairs preferably occurs in relation to container covers 308 which are of a conical or paraboloid shape. During the formation of multiple echoes, this causes at least partial focussing of the microwave energy which is radiated by the fill level measurement device 101, and this is reproduced in the form of increased amplitudes of the associated echoes on the echo curve.

FIG. 4 illustrates the physical relationships which can lead to the formation of multiple echoes.

The fill level measuring device 401 produces an electromagnetic pulse 402 by a known process and transmits it towards the filling material surface 105 which is to be measured. The signal arrow 403 sketches the propagation of the signal as a function of the physical distance over time. Part of the transmitted signal is reflected from the surface of the filling material 105, and after a corresponding delay returns to the fill level measurement device. The signal path 404 illustrates this propagation path. On the basis of the received signals, the fill level measurement device forms an echo curve 204, which in a manner conditional on the signal paths 403 and 404 comprises a first echo 206. Parts of the signals are for example reflected again from the container cover 405 or from the fill level measurement device 401, and propagate towards the fill level surface 105, as is shown by the signal arrow 406. This signal component is reflected again by the fill level surface, and returns after a corresponding delay to the fill level measurement device 401, where it is detected as the first multiple echo E_{ML1} 207 of the filling material reflection and imaged onto the echo curve 204. The signal path 407 illustrates the process.

Part of the radiated signal energy 402, which is not reflected from the filling material surface 105, penetrates into the medium 106 and propagates 408 further therein towards the container base 108 at a reduced speed. The signal is reflected from the container base, and after a corresponding delay returns to the fill level measurement device. The signal paths 409 and 410 illustrate the propagation of the signal on this path. It should be noted that the signal propagates at different speeds in the different media, as can be seen in the signal path diagram by way of the different increases in the signal paths 409, 410. The fill level measurement device receives the signal components reflected from the container base, and images these in the echo curve 204 in the form of a bottom echo E_{B} 208. Analogously to the formation of multiple echoes 207, 416 of the filling material reflection, under favourable conditions the formation of one or more multiple echoes of the bottom echo can be observed. The signal paths 411, 412, 413, 414 illustrate the formation of a first multiple echo E_{MB1} 209 of the bottom echo E_{B} 208, which after a corresponding delay is also imaged in the echo curve 204 received by the fill level measurement device.

It is possible in principle to construct higher-order multiple echoes. For this purpose, the signal path diagram shows the signal paths 417 and 418, which are adapted to produce a second-order multiple echo E_{ML2} 415 on the basis of the reflection of the filling material surface. Corresponding higher-order multiple echoes are also possible for the reflection of the container base. The person skilled in the art should have no difficulties in transferring the aspects of the present invention which are disclosed in the following by way of first-order multiple echoes to higher-order multiple echoes. Let the order of a multiple echo be defined as the number of reflections of a transmitted signal on a medium surface of a filling material which is to be measured in the container, reduced by 1. According to this nomenclature, the echo E_{L} is identical to a zeroth-order multiple echo, whereas the echo E_{ML1} is identical to a first-order multiple echo.

Further, mixed signal paths which lead to further echoes within the received echo curves are also possible. Thus, it may for example be possible for the signal, after passing along the signal path 406, to penetrate into the medium and propagate towards the container base. Further, it may for example also be possible for part of the signal energy, after passing along the signal path 411, to be reflected from the filling material surface and propagate directly towards the fill level measurement device again. Mixed signal paths will not be given further consideration in the context of the present invention, since they play virtually no role in practical application. However, a person skilled in the art should have no difficulty in transferring the aspects of the present invention which are disclosed in the following by way of first-order multiple echoes to mixed multiple echoes. In the present context, let mixed multiple echoes be defined as echoes of an echo curve which are caused by signal paths within which a signal produced by the fill level measurement device is reflected from at least two different boundaries of at least one filling material which is to be measured in a container. The present example does not comprise a mixed multiple echo.

The use of a fill level measurement device in a container comprising a built-on dome shaft is not considered very comprehensively. FIG. 5 shows an example of the use of the measurement device 401 according to the invention in a container 501 of this type. The fill level measurement device is not mounted directly at the level of the container cover 502, but is located in a dome shaft 503, which by contrast with the example of FIG. 4 has a physical length of d_{D}>0 in the present case. The mounting position of the fill level measurement device in the dome shaft majorly influences the formation of multiple echoes. The signal path diagram 504 illustrates the formation of multiple echoes in the present case. The signal produced by the fill level measurement device initially propagates through the dome shaft 503 and the actual container to the surface of the medium 505. The signal path 506 illustrates this signal path. The medium reflects the signal, whereupon this signal is propagated towards the fill level measurement device 401. Since the opening 513 of the dome shaft 503 is small relative to the container cover 502, only a very small part of the signal is imaged onto the echo curve 514 as a fill level echo E_{L} 515. The signal paths 507 and 508 illustrate this propagation path. By far the larger part of the signal energy is reflected from the container cover (signal path 509), and reaches the filling material surface again. In this way, after the passage along the signal paths 509, 510 and 511, a first multiple echo E_{ML1} 516 is imaged onto the echo curve. The relationships described for dome shafts also apply analogously to higher-order multiple echoes, as is shown by the signal path 512, but also to bottom-reflection multiple echoes.

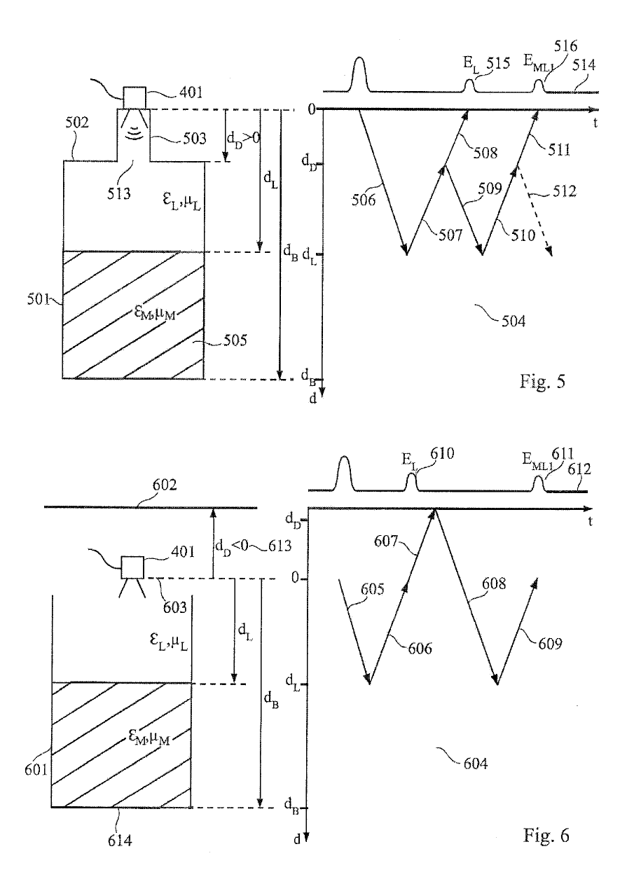

Moreover, in industrial applications, arrangements are found which can advantageously be processed by introducing a negative dome shaft length. FIG. 6 shows an associated application example. The fill level measurement device 401 is mounted above an upwardly open container 601, the whole measurement arrangement being located for example in a hall, in such a way that a metal flat roof 602 may be located above the arrangement. The distance of the reference plane 603 of the fill level measurement device 401 from the hall roof 602 is taken into account in the signal processing sequence of the fill level measurement device 401 as a negative dome shaft length having a physical length d_{D}<0. In the context of the present invention, the application may therefore comprise a dome shaft, which may have a negative length. If the fill level measurement device 401 now carries out measurements, this results in signal paths in accordance with the representation of the signal path diagram 604. The direct reflection of the filling material surface, which is illustrated by the signal paths 605 and 606, is imaged into the echo curve as a fill level echo E_{L} 610. However, by far the larger part of the signal energy is propagated to the hall roof 602, is reflected therefrom, and after further reflection from the filling material surface leads to the first multiple echo E_{ML1} 611 within the echo curve 612. The signal propagation which leads to this echo is indicated by the signal paths 607, 608 and 609.

In practice, multiple echoes and bottom echoes may often lead to considerable problems. Starting from the often encountered ratios of the echo curve 302 in FIG. 3, in the simplest case fill level measurement devices always identify the largest echo of the echo curve 302 as the filling material echo caused by the filling material surface. In the application example of FIG. 3, this leads to an incorrect measurement. Further, it is not possible to remedy this using an error memory, because when the position of the filling material surface was changed, the multiple echoes E_{ML1} and E_{ML2} 305, 306 would move away from the statically applied error echo profile.

Solution approaches currently under discussion provide processes which recognise from among the echoes in an echo list precisely those which are caused by multiple reflection.

Many approaches for detecting multiple echoes may have considerable weaknesses.

Thus, multiple echo detection on the basis of the position of individual echoes can work if the reference point of the sensor corresponds to the shared reflection point of the multiple echoes on the container cover. If the fill level measurement device is mounted in a dome shaft or in upwardly open containers, the process does not lead to meaningful results. No process is known which caters to the problems of a dome shaft length unequal to 0.

Further, many approaches assume that detection of the fill level echo which is produced by the medium surface in the container has already taken place in advance. In situations such as those in FIG. 3, these approaches do not lead to reliable classification of the discovered echoes.

Moreover, approaches for detecting multiple echoes on the basis of speed comparisons or trend lines assume that echoes having an identical reflection point in the container can reliably be assigned or grouped so as to detect the speed or the trend of an echo. It will be obvious to a person skilled in the art that a grouping of this type, such as can for example be provided by a tracking process, can always suffer from errors.

Therefore, approaches of this type for detecting multiple echoes do not provide a robust process which would lead to improvements in the context of fill level measurement under real conditions. Further, with the above-mentioned processes, it is not possible also to analyse multiple reflections of a separating layer or of a container base as well as detecting multiple reflections of the fill level surface.

In accordance with one aspect of the present invention, a robust process and a device are provided for detecting multiple echoes and base echoes. In accordance with a further aspect of the present invention, a process and a device are provided for detecting uncorrelated echoes or anti-correlation echoes.

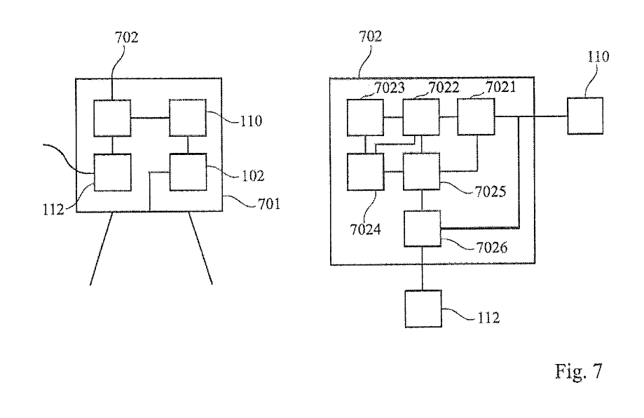

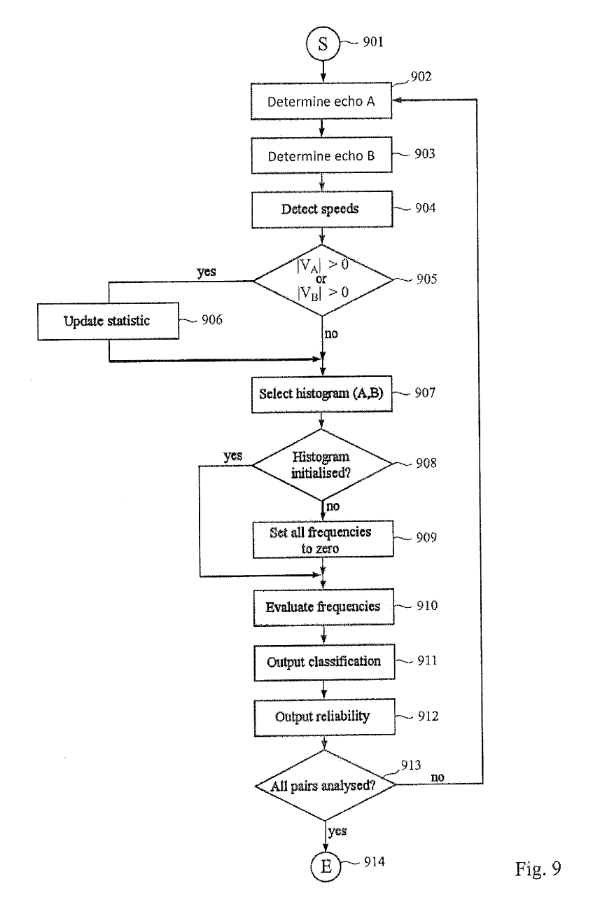

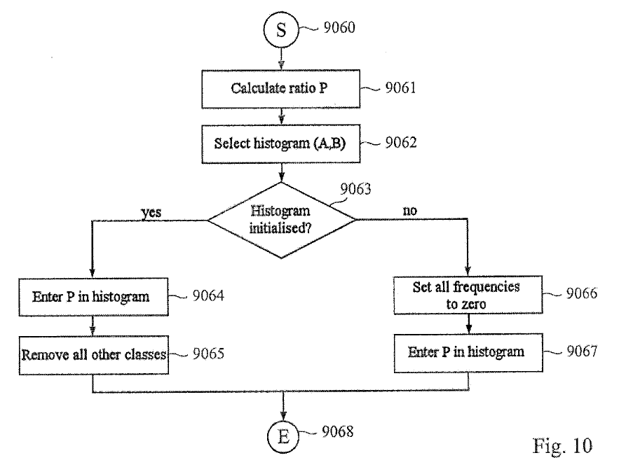

The flow charts of FIG. 9 and FIG. 10 show by way of example a possible sequence of steps for carrying out the process according to one aspect of the invention. The block diagram of FIG. 7 shows an example of a device for implementing the process steps.

The fill level measurement device 701 largely corresponds to the fill level measurement device 101 described in relation to FIG. 1, but differs by way of an evaluation means 702 which is modified by comparison with devices used in the past.

The evaluation means 702 according to the invention may consist of an echo identification means 7021, a tracking means 7022, a speed detection means 7023, a statistical means 7024, a decision means 7025 and an echo measurement means 7026.

The echo identification means 7021 analyses the echo curve provided by the echo curve detection means 102, 110 for echoes 205, 206, 207, 208, 209 comprised therein. The tracking means 7022 groups echoes from different measurement cycles in such a way that echoes which are caused by the same reflection point in the container and which occur on the basis of the same signal path are combined into groups. On the basis of these groups, also referred to as tracks, the speed of an echo for example can be reliably detected. The speed detection means 7023 detects at least one characteristic of the speed of the echo of the current echo curve. A statistical means 7024 according to the invention continuously monitors the speed measurements detected for individual echoes of the echo curve, so as to form therefrom a histogram showing the ratio of the speed value of two echoes. On the basis of these determined statistical values, the statistical means may provide, for each echo of the echo curve, a classification by means of which it can be assigned to one of the classes multiple echo, bottom echo or anti-correlation echo, on the basis of a postulated or actual position of the filling material reflection. On the basis of all the values determined thus far, the decision means 7025 may make a decision as to which echo of the echo curve was produced by the filling material reflection. By way of the echo measurement means 7026, the exact position of the echo can be determined. Further, effects of a superposed medium can be compensated.

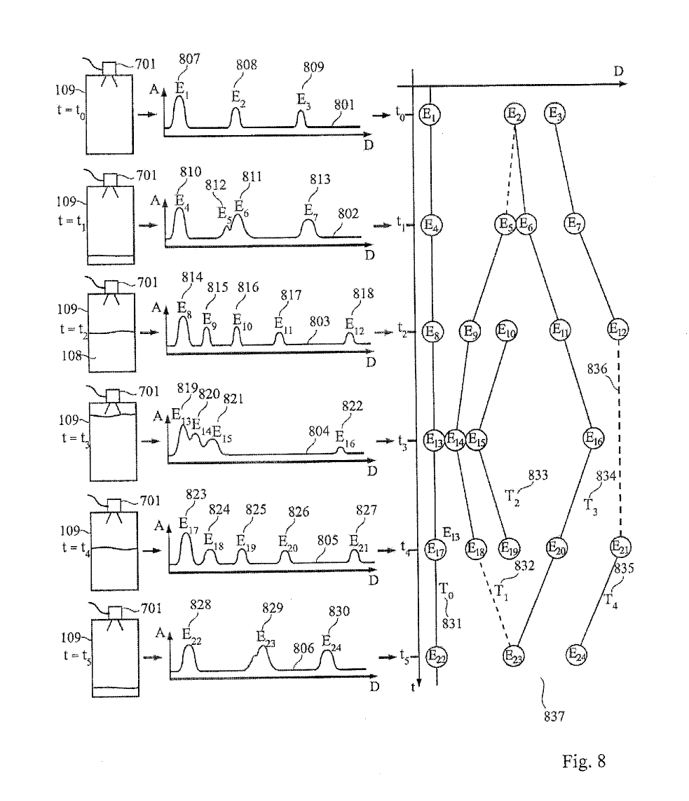

The drawing of FIG. 8 shows a sequence of measurement cycles, such as can be carried out with a measurement device 701 according to the invention. The container 109 which is to be monitored is initially filled with a medium 106 at sequential times to t₀<t₁<t₂<t₃<t₄<t₅, and subsequently emptied again. The echo curves 801, 802, 803, 804, 805, 806 which are detected by a fill level measurement device 701 according to the invention at the respective times are sketched directly alongside the drawing of the container at the respective time.

Apart from the antenna echo E₁ 807, the echo curve 801 of the empty container 109 merely comprises an echo E₂ 808 which is caused by the base and a further multiple echo E₃ 809 of the base reflection. These echoes are detected by the echo identification means, but there is not yet any classification of the echoes at this time. The echoes are therefore preferably provided with different indices, in such a way that they can be processed further algorithmically.

On the basis of the identified echoes E₁ 807, E₂ 808 and E₃ 809, the tracking means 7022 attempts in a further processing step to place the identified echoes in a logical relationship with previously identified echoes. Disclosures on carrying out a tracking process in the context of fill level measurement technology can be found for example in WO 2009/037000. The tracking means 7022 of the fill level measurement device 701 may initialise a first track T₀ 831 on the basis of the antenna reflection E₁. Further, a track T₃ 834 for following the bottom echo E₂ 808 and a track T₄ 835 for following the multiple echo E₃ 809 may be initialised at time t=t₀.

At time t=t₁, the container may be slightly filled. The echo curve 802 detected by the fill level measurement device is shown in FIG. 8. The tracking unit of the fill level measurement device 701 continues the previously started tracks T₀ 831, T₃ 834 and T₄ 835 with the echoes of the current measurement which respectively originate from the same reflection point in the container. Further, a new track T₁ 832 is initialised for monitoring the newly formed fill level echo E₅ 812.

Subsequently, the container is increasingly filled. At time t=t₂, the container may be half full. In accordance with the discussions of FIG. 2, at this stage, a multiple reflection E₁₀ 816 of the filling material surface and also a multiple reflection E₁₂ 818 of the container base are imaged onto the detected echo curve 803. The newly formed multiple reflection of the filling material surface leads to re-initialisation of a track T₂ 833, whilst the previously existing tracks T₀ 831, T₁ 832, T₂ 834 and T₄ 835 are continued with the echoes of the respectively identical reflection point in the container.

The container is shown virtually completely filled with the medium 106 at time t=t₃. Because of the high attenuation of the used measurement signals of the fill level measurement device 701 within the medium 106, it may now no longer be possible to detect the first multiple reflection of the container base. However, the tracking process is able to take into account the absence of this echo, for example by introducing an invisible path 836 within the track T₄ 835. The other tracks are extended with the detected echoes of the echo curve 804 in accordance with the above description.

During the subsequent emptying of the container, the first multiple reflection E₂₁ 827 of the container base reappears at time t=t₄. The associated track T₄ 835 is again continued with the multiple echo of the bottom reflection. Further, the existing tracks are extended in a known manner.

For each of the measurement cycles carried out at the times t₀<t₁<t₂<t₃<t₄<t₅, the sensor comprises a track list, which is provided by the tracking means 7022 and which describes the current tracks 837 at the respective time. The track list may for example consist of vectors, which describe the locations of the respectively assigned echoes for each track. However, it may also be possible to use a memory-optimised representation, such as is disclosed in EP 09 172 769. The process proposed therein also provides the possibility of subdividing a track, that is to say a sequence of echoes having an identical reflection origin, into temporal portions in which the assigned echo has a virtually constant speed or a virtually constant speed vector.

In the context of the further signal processing, an analysis for multiple echoes and bottom echoes is preferably carried out on the basis of the tracks 831, 832, 833, 834, 835. From the representation 837 of the tracks, it can be seen simply visually that the echoes of the track T₂ 833 are multiple echoes of the respective echoes of the track T₁ 832, since the track T₂ moves uniformly in the same direction as the track T₁. It can further be seen from the drawing that the echoes of the track T₃ describe the base of the container, since they move counter to the direction of movement of the fill level echo of the track T₁.

These relationships are analysed in the sensor by way of the interplay of the speed detection means 7023 and the statistical means 7024. A suitable sequence for carrying out the process is shown in FIG. 9.

The process for analysing the detected echo for multiple echo and bottom echo properties starts in the starting state S 901. In step 902, a first echo is selected from the plurality of detected echoes of the current measurement. According to the invention, if there is no knowledge of the precise relationships in the container for the starting analysis step, the selected echo A is postulated to be a filling material echo. It is thus subsequently assumed that the selected echo was caused by a reflection from the filling material surface 105, 309. Subsequently, in step 903, a further echo from the echo list is selected, this echo B being analysed for multiple echo and bottom echo properties on the basis of the hypothesis that echo A is the filling material echo. Since multiple echoes and bottom echoes always have a distance value which is greater than the distance value of the current filling material reflection, in this step the calculation can be simplified in that only echoes B having a distance greater than the distance of the echo A are selected.

In the following, an exemplary configuration of the process is described in greater detail. Now, multiple echoes can be detected on the basis of position comparisons, or else on the basis of speed comparisons, between two echoes. Because of the generally encountered problems of an unknown dome shaft length, the following variant of the process according to the invention is described exclusively by way of processing the speeds of two echoes. However, it may also be possible to carry out the process and in particular to produce a statistic using characteristics which are determined on the basis of the position of individual echoes. It may additionally be possible to combine position and speed properties, so as to generate information on multiple echo and bottom echo properties therefrom in connection with the statistical means.

In step 904, the speed detection means calculates the speed of the two selected echoes A and B. This analysis may be based on local increases in a track.

Alternatively, the speed V_{E} of an echo E, of a track or of a reflection can be determined from a position shift of the echo, track or reflection between two different measurement cycles of the fill level measurement device, in accordance with the following formula:

$${V}_{E} = \frac{{D}_{E} ( {t}_{2} ) - {D}_{E} ( {t}_{1} )}{{t}_{2} - {t}_{1}}$$

wherein D_{E}(t₂) is the electrical distance of the echo, track or reflection in the measurement cycle 2, D_{E}(t₁) is the electrical distance of the echo, track or reflection in the measurement cycle 1, t₂ is the time at which the measurement cycle 2 is carried out, and t₁ is the time at which the measurement cycle 1 is carried out.

By applying regression processes, it is also possible to use a plurality of positions of the echo of a track to determine the speed of an echo. However, it may also be possible to determine the speed for whole portions of a track in which the speed of the echo is virtually constant. The process disclosed in EP 2309235 A1 can be used for converting a track into portions having constant speeds.

However, it may also be possible to detect at least one characteristic of the speed of an echo on the basis of Doppler analysis or by evaluating phase shifts of temporally sequential echo curves. A characteristic of the speed of an echo may be the value of the speed. Further, a characteristic of the speed of an echo may be the direction of the speed.

In process step 905, it is now analysed whether at least one of the two echoes moves.

Because the generally encountered problem of an unknown dome shaft length for detecting multiple echoes and bottom echoes means that the present embodiment is not based on the absolute position information of the individual echoes, at least one of the echoes under consideration must exhibit a movement in such a way that an analysis for multiple echo and bottom echo properties can be carried out as the sequence continues.

If at least one of the two selected echoes exhibits movement, the speed statistic associated with the selected echo is updated within the statistical means 7024 in step 906.

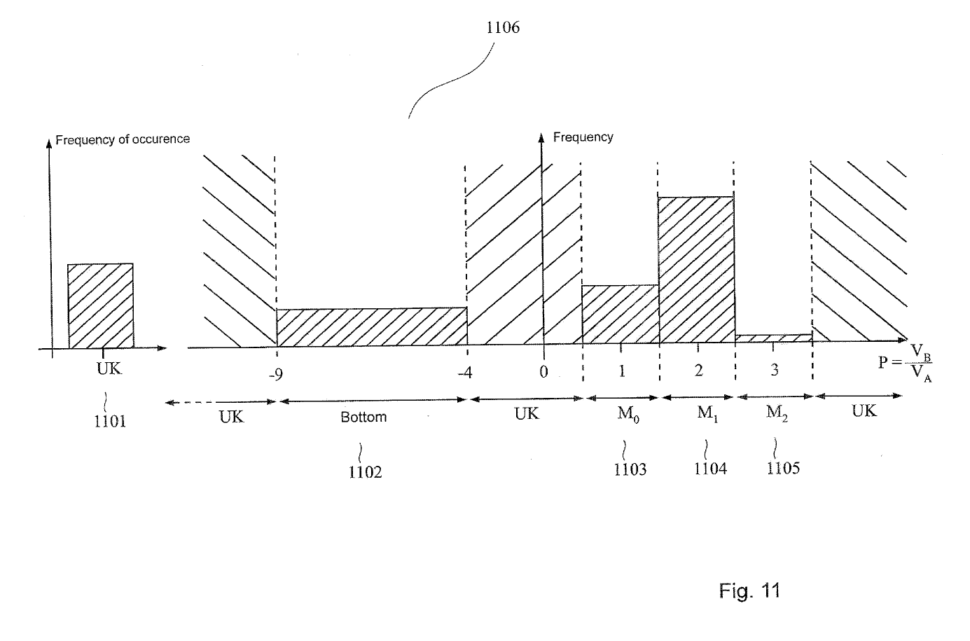

The statistical means 7024 carries a respective statistic, in the form of a histogram according to the scheme of FIG. 11, for every possible combination of multiple echoes and bottom echoes of the current measurement. In step 906, the statistic associated with the currently selected echoes A and B is updated. FIG. 10 shows the steps required for this purpose.

In step 9061, the ratio P of the speeds of the two currently selected echoes A and B is calculated in the following manner:

$${P}_{A , B} = \{ \begin{matrix}\frac{{V}_{B}}{{V}_{A}} & if \vert {V}_{A} \vert > 0 \\ 0 & otherwise\end{matrix}$$

wherein V_{A} is the speed of the postulated filling material echo A, and V_{B} is the speed of the echo B which is to be analysed for multiple echo and bottom echo properties.

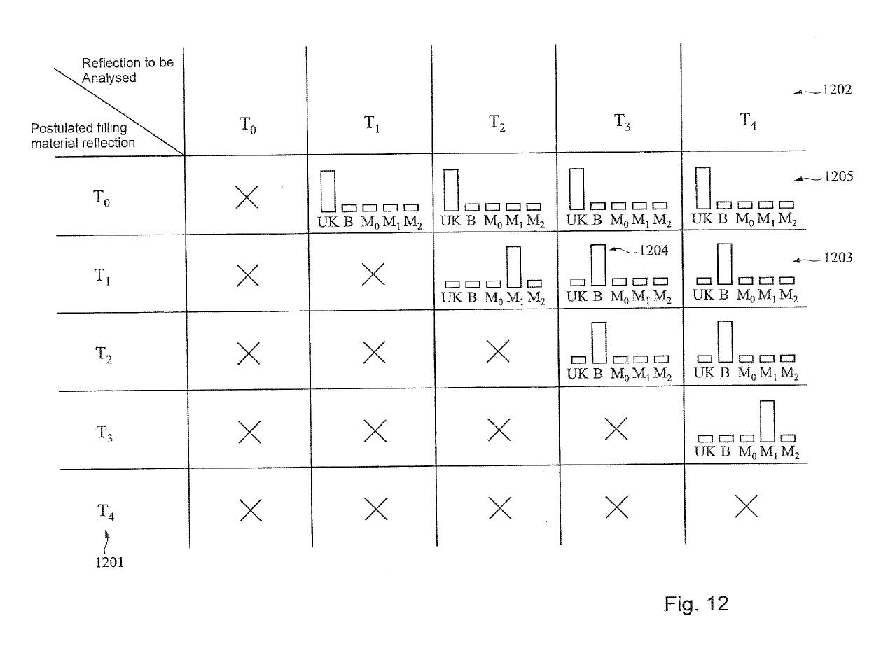

In process step 9062, the histogram associated with reflection A and reflection B is selected from the memory of the statistical unit. The statistical unit stores a plurality of histograms, such as are shown in FIG. 12, for this purpose. In particular, the statistical unit reserves a histogram according to the scheme of FIG. 11 for each combination of two echoes or tracks which corresponds to the constraint in relation to possible locations.

In step 9063, it is checked whether the histogram associated with the selected reflections A and B has already been initialised in one of the preceding measurement cycles.

If the histogram is already populated, the presently detected speed ratio P is entered in the histogram in step 9064. Subsequently, all other classes of the histogram are removed 9065.

Steps 9064 and 9065 are described in greater detail in the following by way of a histogram according to the invention in accordance with FIG. 11.

If the result of the calculation is that the two echoes are moving at approximately the same speed, corresponding to a speed ratio P in the range of from 0.5 to 1.5, the current echo ratios mean that echo B is a zeroth-order multiple echo of the echo A or is the reflection A. Consequently, the column 1103 for M0 is increased by one or by an amount which can be specified in advance. At the same time, this classification contradicts all other conceivable classifications. The columns for no correlation UK, 1101, base 1102, first-order multiple echo M1, 1104 and second-order multiple echo M2, 1105 are therefore reduced by an amount which can specified in advance.

If the result of the calculation is that the echo B is moving approximately twice as fast as the echo A, corresponding to a speed ratio P in the range of from 1.5 to 2.5, the current echo ratios mean that the echo B is a first-order multiple echo. Consequently, the column for M1 1104 is increased by one or by an amount which can be specified in advance. At the same time, this classification contradicts all other conceivable classifications. The columns for no correlation UK, 1101, base 1102, zeroth-order multiple echo M0, 1103 and second-order multiple echo M2, 1105 are therefore reduced by an amount which can specified in advance.

If the result of the calculation is that the echo B is moving approximately three times as fast as the echo A, corresponding to a speed ratio P in the range of from 2.5 to 3.5, the current echo ratios mean that the echo B is a second-order multiple echo. The entry in the histogram is produced according to the scheme described above.

If the calculation results in a negative ratio P in the range of from −9 to −4, it can be concluded that the echo B is a bottom echo in relation to the reflection A. Accordingly, the column for base 1102 is increased by one or by an amount which can be specified in advance. At the same time, this classification contradicts all other conceivable classifications. The columns for no correlation UK, 1101, zeroth-order multiple echo M0, 1103 first-order multiple echo M1, 1104 and second-order multiple echo M2, 1105 are therefore reduced by an amount which can specified in advance.

The restriction of possible negative speed ratios to the range between −9 and −4 can be altered in a manner specific to the application. However, it has been found in a number of applications that real bottom echoes lead to a ratio P in the specified range.

It is further postulated in the shown histogram that only multiple echoes of up to an order of 2 can occur in the current application. Naturally, the process can also be extended in such a way that further columns are provided for higher-order multiple echoes. However, on the basis of the ratios observed thus far in real applications, a restriction to the analysis up to second-order multiple echoes seems expedient and sufficient.

If the analysis of the speed ratios between the echo A and the echo B does not result in an assignment to any of the ranges of the base or the multiple reflections M0, M1, M2, it must be assumed that the echo B is in no way related to the echo A, that is to say the two echoes are completely uncorrelated. Accordingly, the column for no correlation UK, 1101 is increased by one or by an amount which can be specified in advance. At the same time, this classification contradicts all other conceivable classifications. The columns for base 1102, zeroth-order multiple echo M0, 1103 first-order multiple echo M1, 1104 and second-order multiple echo M2, 1105 are therefore reduced by an amount which can specified in advance.

If, when checking step 9063, it results that the histogram is not yet initialised, that is to say the selected echo A or the selected echo B in the current measurement cycle cannot yet be assigned to any of the reflection points or tracks which have been processed in the sensor thus far, the analysis must be re-initialised by way of the histogram of FIG. 11. For this purpose, all of the entries of the histogram are initially set to 0 in step 9066. Subsequently, in step 9066, the speed ratio of the current measurement is entered in the histogram in the manner described above.

In step 907 of FIG. 9, the histogram 1106 associated with the selected echoes A and B is selected again. In steps 908 and 909 it is checked whether the histogram is already initialised, and if necessary it is initialised in accordance with the scheme described above.

In step 910, the frequencies of the current histogram are analysed. Referring to the example of FIG. 11, it is analysed which of the classifications 1101, 1102, 1103, 1104, 1105 has the absolutely largest frequency. In the present case, the largest frequency is found in the column of the first multiple echo M1, 1104. Therefore, in step 911, the echo B currently under consideration is classified as a first-order multiple echo. Further, again referring to FIG. 11, it is analysed which classification 1101, 1102, 1103, 1105 has the second largest absolute frequency. In the present example, this may be the classification in “uncorrelated echoes” or “anti-correlation echo” 1101. From the difference between the frequency of the current classification and the value of the frequency of the second-largest classification, in step 912 a reliability level is calculated and outputted. Since in the present example the frequency for the first-order multiple echo is only slightly greater than the frequency for “uncorrelated echoes”, it is not possible to put especially great trust in the provided classification, and this is reflected in a low value for the reliability of the classification.

In step 913, the analysis is initiated for the next echo pair, if not all logically possible echo pairs have yet been considered. The process ends at step 914.

The proposed process does not require any information as to which of the currently identified echoes is the filling material echo. Rather, a plurality of echoes are successively postulated to be a possible filling material reflection. Subsequently, all echoes having a distance greater than the currently postulated filling material reflection are analysed for multiple echo and bottom echo properties.

FIG. 12 shows the resulting combinatoric diversity in the statistical unit, building on the ratios from FIG. 8. For simplification, in the present example, the analysis for multiple echo and bottom echo properties is only carried out for echoes which can be assigned to a track by the tracking means.

The drawing clarifies that all existing tracks are postulated 1201 to be a filling material reflection. Further, all existing tracks are also analysed 1202 for multiple echo and bottom echo properties. Because of the restriction that multiple echoes and bottom echoes can only occur at a distance greater than the location of the currently postulated filling material reflection, an evaluation is only produced for the combinations in the upper right-hand half 1203 of the table. The physically impossible combinations are not evaluated by way of histograms, since they are guaranteed not to be multiple echoes or bottom echoes on the basis of the respectively postulated filling material reflection. Impossible combinations are marked with an X in the drawing of FIG. 12.

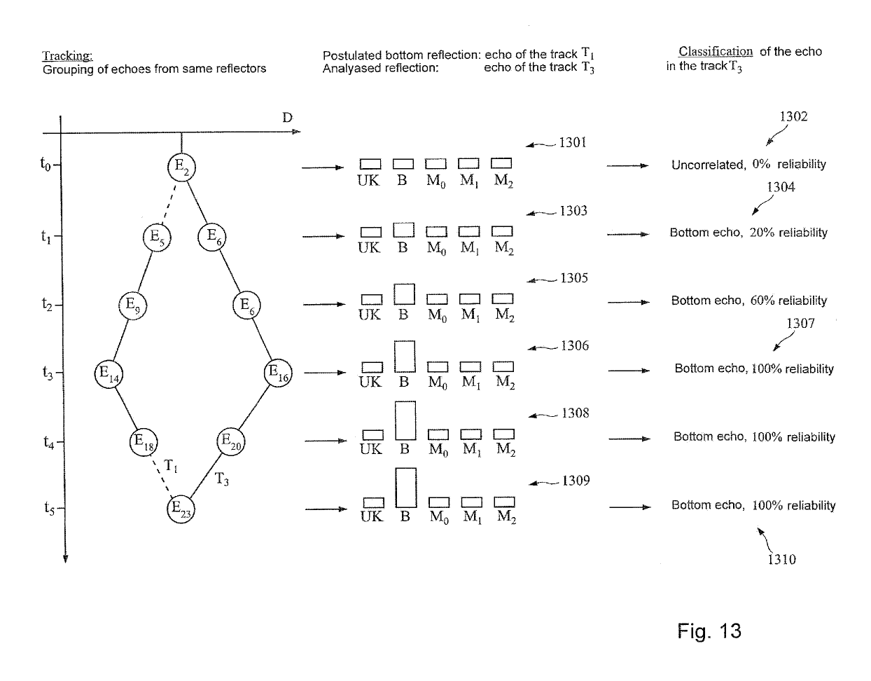

FIG. 13 shows the development of the histogram 1106 over time, at times t₀<t₁<t₂<t₃<t₄<t₅, by way of a combination 1204 which is specifically to be analysed for the echoes of the track T1, which may be postulated to be a fill level track, and the echoes of the track T3, which is to be analysed for multiple echo and bottom echo properties. The paths of the echoes and the grouping into tracks may correspond to those of the example of FIG. 8.

At time t=t₀, the histogram 1301 is in the initialisation state, that is to say all frequencies are set to 0. Since at this time none of the feature classes UK, B, M0, M1, M2 stands out from the histogram as the dominant class, the echoes E₂ are classified in such a way that the histogram is “uncorrelated” in relation to the postulated filling material reflection, this prediction having zero reliability 1302.

During further development, at time t=t₁, the histogram 1303 exhibits a first frequency in the feature class B, which suggests a bottom echo relationship between the echo E₆ of the track T3 and the postulated filling material echo E₅ of the postulated fill level track T5. The classification of the echo E₆ at this time thus suggests the bottom echo class 1304, but because the frequency of the feature class B is not especially pronounced, this classification can only be made with for example 20% reliability.

Subsequently, at times t=t₂ and t=t₃ 1305, 1306, the frequency within the feature class B becomes more and more strongly pronounced, and therefore at time t=t₃ the echo E₁₆ can be classified as a bottom echo with 100% reliability or prediction strength 1307.

Even after a change in the filling direction, the analysis of the speed ratio of the echoes of track T3 to the echoes of the track T1 does not result in any different classification. The associated histograms 1308, 1309 still have the bottom echo as the dominant feature class B, and accordingly the undertaken classification 1310 is still obtained with 100% reliability.

At this point, it should be noted that once the information as to whether an echo is a bottom echo or a multiple echo has been acquired, it is still obtained in periods in which the container is neither being filled nor being emptied. In process step 905 in FIG. 9, it would be established that neither the echo A nor the echo B exhibits any movement, and therefore the previous histogram would be kept unchanged. This constitutes a significant difference from known processes, and makes possible the particularly advantageous application of the process in the field of fill level measurement, where stationary ratios still continue to occur, for example when a system is idle over the weekend.

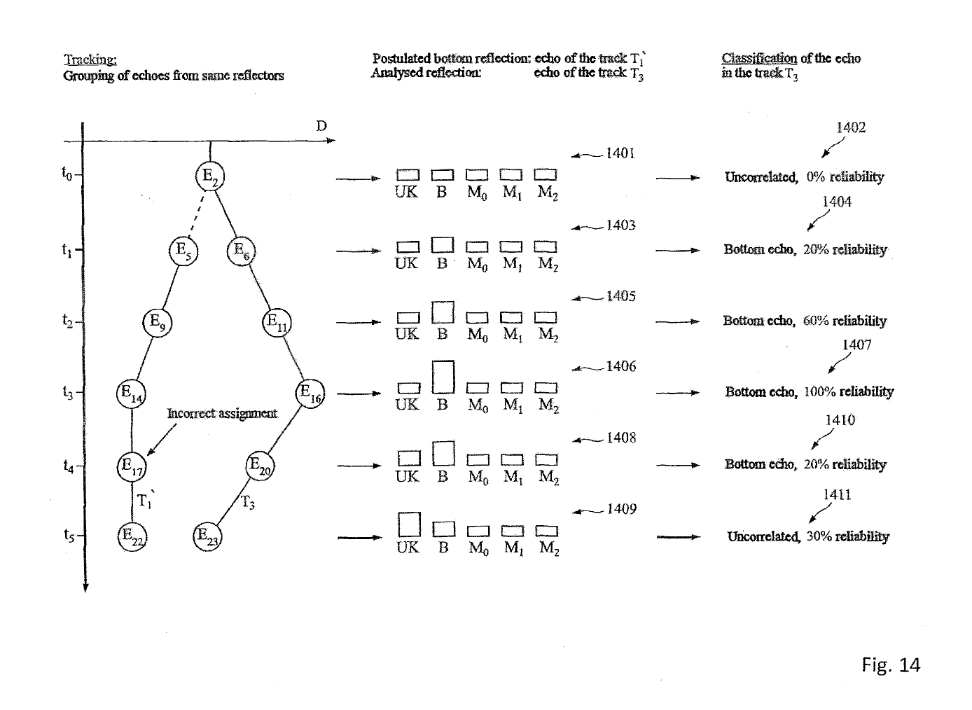

Moreover, however, the proposed process also offers the possibility of revising a classification that has already been made if an echo has been incorrectly assigned to a track. FIG. 14 shows an example of an incorrect assignment of the echo E₁₇ to the track T1′. As a result of identical assignment of the echoes to the tracks, the histograms 1401, 1403, 1405 and 1406 at the times t=t₀ to t=t₃ correspond exactly to those of FIG. 13. Consequently, in FIG. 14 too, the echo E₁₆ is classified 1407 as a bottom echo associated with a (postulated) filling material echo E₁₄. The frequency of the feature class B for the bottom echo in the histogram 1406 protrudes a long way above all the other frequencies, and therefore at time t=t₃ the classification can be made with a reliability of 100%.

At time t=t₄, the echo E₁₇ may be detected as the echo which originates from the same reflection point as the echoes E₅, E₉ and E₁₄ in the container, for example on the basis of slightly altered amplitude ratios of the tracking means 7022. The echo E₁₇ is consequently incorrectly assigned to the track T1′.

In the context of carrying out process step 9064 of FIG. 10, the statistical means 7024 according to the invention for evaluating the ratios of the speeds of two echoes now establishes that the echoes of the track T1′ and the echoes of the track T3 no longer match one another.

Consequently, in the histogram 1408, the frequency within the feature class UK for uncorrelated echoes increases, whilst the frequency of the feature class B is reduced 1408, 1409. The current classification of the echo E₂₀ at time t=t₄ therefore still points to a bottom echo, since the feature class B of the currently present histogram 1408 still has the highest frequency, as before. However, the reliability of this prediction 1410 decreases enormously, since the distance between the frequency of the feature class B and the frequency of the feature class UK is still only very small in the histogram 1408.

Subsequently, the previously made classification is revised again. At time t=t₅, the frequency of the feature class UK for uncorrelated echoes is further increased, and consequently the frequency of the feature class B in the histogram 1409 is further reduced. Since the feature class UK now has the greatest frequency, the echo E₂₂ of the track T3 is now no longer considered to be a bottom echo for the (postulated) filling material reflection E₂₂ of the track T1′. Rather, the process points to “the echoes not being correlated” or an “anti-correlation echo”, that is to say there is a probability or reliability of 30% 1411 that the echo E₂₂ is not in a causal relationship with the echo E₂₂.

The proposed process for detecting multiple echoes, bottom echoes or anti-correlation echoes differs considerably from the previously known processes.

A particular advantage of the proposed process is the possibility of classifying echoes without previously identifying a filling material echo. In this regard, the process differs from other processes precisely in that an analysis is carried out systematically on the basis of a plurality of postulated filling material echoes. The combinatoric complexity of the calculation is effectively reduced by taking into account physical data relating to the locations of the respective echoes.

The proposed process further opens up the possibility of a continuous calculation of the multiple echo, bottom echo and anti-correlation echo properties of identified echoes. First, this opens up the possibility of carrying out classification of the discovered echoes in periods of stationary filling ratios. Previously known processes did not work when there was no movement, since it is not possible to determine the speed in these periods. Further, the continuous calculation makes it possible to revise a previously made classification, and this is also not possible with known processes.

Moreover, the proposed process provides a possibility of grouping echoes into one of the groups selected from anti-correlation echoes, multiple echoes or bottom echoes, and determining the reliability of the classification.

Anti-correlation echoes were previously completely unknown as an echo group. In the context of the invention, anti-correlation echoes may all be echoes which are neither in a multiple echo relationship nor in a bottom echo relationship with a filling material reflection. The movement of anti-correlation echoes does not exhibit any relationship to the movement of a filling material echo. Typical examples of anti-correlation echoes may be echoes which are found at random in the noise of a signal. Further, anti-correlation echoes can always occur in the proposed process if an echo of an interference point which is fixed in the container is incorrectly postulated 1205 to be a filling material reflection.

In connection with the definition of an echo group for anti-correlation echoes, the proposed process further defines a methodology for simultaneous analysis of echoes, so as to form a temporal and logical unit, for multiple echo, bottom echo or anti-correlation echo properties. Previously used processes concentrated purely on the analysis of multiple echo properties or bottom echo properties. The logical integration of this analysis into just a single process is a further distinguishing feature.

Finally, the proposed process provides a method with which multiple echoes of a bottom echo can also be identified within an echo curve. A person skilled in the art can combine the principles of the invention with the information of a manually inputted or automatically determined container height. By taking into account a container height, the combinatoric diversity of the analysis for multiple echoes and bottom echoes (FIG. 12) can be further reduced. Moreover, by postulating bottom echoes of which the position is located beyond the container height, a search for multiple echoes and bottom echoes can be carried out in accordance with the above scheme.

In the present disclosure, the concept of the dome shaft length is made use of at various points. A dome shaft may be a shaft via which the tank can be filled. A dome shaft may also be in the form of an access path for operating personnel, known as a manhole. Further, it may also be possible to use a dome shaft for other purposes. The fill level measurement device may inter alia be fitted in what is known as the dome, at the top of the tank.

At this point, it should be noted that this value within the signal processing of the sensor can be slightly different from the physically measurable value. First, the zero point of the sensor can be changed by parameterisation. Further, the height for example of a container may be defined in one application as inclusive of a dome shaft mounted thereon, but in other applications, such as in the case of a negative dome shaft length, this definition does not make sense. Therefore, in the context of the present invention, the relevant values should define numerical values which are related to the physical values and by means of which specific processes, in particular indirect measurement of the filling material position, can be carried out.

It should further be mentioned that the disclosed technical teaching is just as suitable for FMCW fill level measurement as for guided microwave, ultrasound or laser fill level measurement or any other delay-based process.

In addition, it should be noted that “comprising” and “having” do not exclude the possibility of other elements or steps, and “a” or “an” does not exclude the possibility of a plurality. It should further be noted that features or steps which are described in reference to one of the above embodiments may also be used in combination with other features or steps of other above-described embodiments. Reference numerals in the claims should not be taken as limiting.

1. A fill level measurement device for determining at least one of (a) a position of a fill level and (b) a separating layer in a container, comprising:
an echo curve detection unit detecting an echo curve;
an echo identification unit identifying at least two echoes in the echo curve; and
a speed detection unit detecting speed values of the at least two echoes,
wherein the fill level measurement device is configured to postulate one of the identified echoes to be the fill level echo, followed by an echo classification of the at least one other echo, taking into account a sign of a ratio of the detected speed values, and
wherein the echo classification assigns at least two of the identified echoes of the echo curve to a feature class selected from a group comprising the feature classes bottom echo, multiple echo, anti-correlation echo and filling material echo.

2. The fill level measurement device according to claim 1, further comprising:
a statistics unit evaluating statistical properties of a shared characteristic of at least two echoes, the shared characteristic being a ratio of the detected speed values of two of the at least two echoes;
wherein the fill level measurement device is configured so as to carry out an echo classification of at least two of the identified echoes in the echo curve as a result of the evaluation of the statistical properties of the shared characteristics of identified echoes.

3. The fill level measurement device according to claim 1, further comprising:
a tracking unit placing identified echoes in a logical relationship with previously identified echoes, the tracking unit estimating a probable position of an echo if this echo is absent from the echo curve.

4. The fill level measurement device according to claim 1, wherein the statistics unit determines the characteristics of at least one pair of the identified echoes.

5. The fill level measurement device according to claim 2, wherein the statistics unit represents the echo classification as a histogram, in which each possible feature class is assigned a probability, which expresses how great the statistical probability is that the corresponding echo belongs to the corresponding feature class.

6. The fill level measurement device according to claim 1, wherein the device is configured so as to confirm or revise the echo classifications by detecting and evaluating a further echo curve.

7. The fill level measurement device according to claim 1, wherein the device is configured for simultaneous identification of multiple echoes and bottom echoes.

8. A method for determining a position of at least one of (a) a fill level and (b) a separating layer in a container, comprising the following steps:
detecting an echo curve;
identifying at least two echoes in the echo curve;
detecting speed values of the at least two echoes;
postulating one of the at least two echoes to be the fill level echo; and
carrying out an echo classification of the at least one remaining echo, taking into account a sign of a ratio of the detected speed values,
wherein the echo classification assigns at least two of the identified echoes of the echo curve to a feature class selected from a group comprising the feature classes bottom echo, multiple echo, anti-correlation echo and filling material echo.

9. The method according to claim 8, further comprising the steps of:
a) identifying a plurality of echoes in the echo curve; and
b) carrying out an echo classification of at least two echoes in the echo curve as a result of the evaluation of the statistical properties of the shared characteristics of identified echoes;
wherein the echo classification assigns at least two of the identified echoes of the echo curve to a feature class selected from a group comprising the feature classes bottom echo, multiple echo, anti-correlation echo and filling material echo.

10. The method according to claim 8, further comprising the steps of:
postulating another echo of the identified echoes to be the fill level echo;
carrying out an echo classification of at least one of the remaining echoes,
wherein each echo classification comprises a classification of at least one further identified echo and a calculation of the corresponding probabilities of a correct classification.

11. The method according to claim 8, further comprising the step of:
confirming or revising the echo classifications by detecting a further echo curve and carrying out at least steps (a1) and (b), and adapting the corresponding probability of a correct classification.

12. A program element which, when it is executed on a processor of a fill level measurement device, causes the processor to carry out the following steps:
detecting an echo curve;
identifying at least two echoes in the echo curve;
detecting speed values of the at least two echoes;
postulating one of the at least two echoes to be the fill level echo; and
carrying out an echo classification of the at least one remaining echo, taking into account a sign of a ratio of the detected speed values;
wherein the echo classification assigns at least two of the identified echoes of the echo curve to a feature class selected from a group comprising the feature classes bottom echo, multiple echo, anti-correlation echo and filling material echo.

13. A computer-readable medium for storing a program element which, when it is executed on a processor of a fill level measurement device, causes the processor to carry out the following steps:
detecting an echo curve;
identifying at least two echoes in the echo curve;
detecting speed values of the at least two echoes;
postulating one of the at least two echoes to be the fill level echo; and
carrying out an echo classification of the at least one remaining echo, taking into account a sign of a ratio of the detected speed values;
wherein the echo classification assigns at least two of the identified echoes of the echo curve to a feature class selected from a group comprising the feature classes bottom echo, multiple echo, anti-correlation echo and filling material echo.
